(19) United States
(12) Patent Application Publication
(10) Pub. No.: US 2009/0049983 A1
(43) Pub. Date: Feb. 26, 2009

(54) Energy management system for membrane separation device

(75) Inventor: John E. Thelen, Ocala, FL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Flair Corporation, a Delaware Corporation

(21) Appl. No.: 11/892,361

(22) Filed: Aug. 22, 2007

(51) Int. Cl. B01D 46/44; B01D 53/30

(52) U.S. Cl. 95/10; 95/12; 96/408

(57) ABSTRACT

An energy management system for a membrane separation device, including: a membrane having permeate and non-permeate portions; a membrane housing which encases said membrane; a feed fluid inlet conduit; a purge inlet conduit; a non-permeate product fluid outlet conduit; and, a purge outlet conduit, configured to carry purge fluid out of the membrane dryer; at least one purge inlet flow control valve connected to said purge inlet conduit, a sensor configured to measure the contaminant level of fluids exiting the purge outlet conduit; and, a controller receiving an output signal from the sensor and transmitting a valve control signal to the at least one purge inlet flow control valve.

### FIELD OF THE INVENTION

This invention relates generally to an energy management system for a membrane separation device. More particularly, the invention relates, for example, to regulating purge flow rate to reduce excessive purge fluid consumption.

### BACKGROUND OF THE INVENTION

It is known in the art that compressed air, which has several uses including in food packaging, pharmaceutical labs and integrated circuit manufacturing, may be treated to remove contaminants and water vapor. Compressed air is treated before use in manufacturing systems to remove water vapor and contaminants from the air that may spoil the end product or at least increase the cost of production by robbing the system of power and efficiency. As untreated compressed air is moved through a system, the temperatures may drop, which in turn may cause the water vapor to condense. The introduction of water may cause rust or leakage of the air lines. With conventional compressed air treatment equipment, system power may be preserved, operating expenses may be reduced, and production quality may be improved by removing water vapor from compressed air.

It is known in the art that cleaning compressed air using a membrane dryer removes contaminants and water vapor and also, reduces its dew point, which is the temperature at which the air must be cooled, at constant barometric pressure, for the water vapor component to condense into water. Compressed air may be moved through a bundle of hollow fibers, which may be composed of a membrane specifically designed to attract water vapor. Thus, as compressed air passes on one side of the membrane, the water vapor is absorbed into the membrane, passing quickly through, where it is desorbed into the purge stream on the opposite side of the membrane. The dryer is driven by the differential in water vapor pressure across the membrane. Conventional membrane dryers use a portion of the dried compressed air as the purge stream. This dried air is expanded to low pressure to further reduce the water vapor partial pressure, thus increasing the driving force for the process. The purge air stream flushes the water vapor from the permeate side of the hollow fibers and thus, continuously purges the membrane of water vapor.

Similarly, separation of other fluid mixtures may be accomplished by passing the fluid mixture on one side of a semi-permeable membrane, as long as there is one or more highly permeable components and other less permeable components. The membrane may then be purged by sweeping the system using the stream that has been stripped of the highly-permeable component. The purge stream would then carry the more permeable components out of the system.

In conventional membrane gas separation devices, continuous sweep or purge may be used to increase the partial pressure differential that drives the system, improve the product gas purity and enhance productivity of the membrane. However, the continuous purge of the membrane can be very expensive. In the case of a membrane air dryer, continual purging of the membrane dryer with a constant flow from the dryer outlet wastes resources because whenever the dryer is used at less than design capacity, lower purge rates can be used to maintain product purity.

Many membrane gas separation systems require the use a purge gas stream to carry off the gas constituents that permeate the membrane wall. Most conventional membrane separation systems continuously purge at a constant rate. Attempts have been made to decrease the amount of gas used to sweep the membrane but these previous systems control purge by monitoring the outlet gas purity which can be very costly because instrumentation capable of monitoring low contaminant levels at the outlet is often expensive. Because this purge stream comprises the primary operating cost associated with operating a membrane separation system, there is a benefit in minimizing the purge flow rate without adding costly instruments to the system. Accordingly, it is desired to provide a system that selectively purges the membrane while avoiding excess purging.

### SUMMARY OF THE INVENTION

The foregoing needs are met, to a great extent, by the invention, wherein aspects of an energy management feature may be added to membrane separation system to allow selective purge of the membrane. The invention enables a gas separation system that selectively purges the membrane by monitoring the amount of permeate being carried out with the purge outlet stream. Example embodiments of the invention provide an energy management system which regulates the purge flow rate based on the relative humidity (RH) of the purge outlet stream.

In accordance with an embodiment of the invention, an energy management system for a membrane separation device may include a membrane separation device, having: a membrane having permeate and non-permeate portions; a membrane housing which encases said membrane; a feed fluid inlet conduit; a purge inlet conduit; a non-permeate product fluid outlet conduit; and, a purge outlet conduit, configured to carry purge fluid out of the membrane separation device. In some embodiments, the membrane separation device includes an integral purge control feature. In other embodiments, the membrane separation device may include hollow fiber membranes. The membrane separation device may also include a membrane dryer.

The energy management system may also include at least one purge inlet flow control valve connected to said purge inlet conduit; an exhaust sensor configured to measure an exhaust permeate fluid concentration of fluids exiting the purge outlet conduit; and, a controller receiving an output signal from the exhaust sensor and transmitting a valve control signal to the at least one purge inlet flow control valve. In some embodiments, the exhaust sensor may include a relative humidity transmitter configured to measure the exhaust relative humidity of fluids exiting the purge outlet conduit. In example embodiments, the at least one purge inlet flow control valve is configured to provide continuously modifiable flow rates. In some embodiments, the at least one purge inlet flow control valve includes a plurality of on-off valves each connected to the controller, which for example may include two solenoid valves.

The energy management system may include an inlet sensor configured to measure an inlet permeate fluid concentration of fluids entering the feed fluid inlet conduit. The energy management system may also include an orifice for metering flow into the purge inlet conduit and/or a manifold mounted to the membrane housing. In such an embodiment, at least one purge inlet flow control valve may be mounted to the manifold.

In accordance with the invention, a method of using an energy management system in conjunction with a membrane separation device, includes: directing fluid into the membrane separation device, wherein the membrane separation device comprises: a membrane having permeate and non-permeate portions; a membrane housing which encases said membrane; a feed fluid inlet conduit; a purge inlet conduit; a non-permeate product fluid outlet conduit; and, a purge outlet conduit, configured to carry an exhaust fluid out of the membrane separation device.

The method of using an energy management system in conjunction with a membrane separation device may also include measuring an outlet permeate fluid concentration of fluids exiting the purge outlet conduit using an exhaust sensor; transmitting a first output signal from the exhaust sensor to a controller; transmitting a valve control signal from the controller to at least one purge inlet flow control valve; and directing flow into the purge inlet conduit based on the measured outlet permeate fluid concentration and using the at least one purge inlet flow control valve connected between said purge inlet conduit and said controller.

The method of using the energy management system may further include: measuring an inlet permeate fluid concentration of feed fluid entering the feed fluid inlet conduit using an inlet sensor and transmitting a second output signal from the inlet exhaust sensor to the controller. In some embodiments of the invention, the step of directing flow into the purge inlet conduit using the at least one purge inlet flow control valve connected between said purge inlet conduit and said controller may include configuring the at least one purge inlet flow control valve to provide continuously modifiable flow rates. In some embodiments, transmitting the valve control signal from the controller to the at least one purge inlet flow control valve includes transmitting the valve control signal to a plurality of on-off valves. The method may also include metering flow into the purge inlet conduit using an orifice.

In example embodiments of the invention, an energy management system may include: membrane separation means for separating a permeate fluid from a non-permeate fluid, which may include: membrane housing means for encasing said membrane separation means; feed inlet means for flowing a feed fluid into the membrane separation means; purge inlet means for flowing a purge fluid into the membrane separation means; product outlet means for flowing a product fluid out of the membrane separation means; and, purge outlet means for flowing an exhaust fluid out of the membrane separation means. The energy management system may also include: purge inlet flow control means for controlling the flow of purge fluid into the purge inlet means, exhaust sensor means for measuring an exhaust permeate fluid concentration of exhaust fluid exiting the purge outlet means; and controller means for receiving an output signal from the exhaust sensor means and transmitting a valve control signal to the purge inlet flow control means. The energy management system may further include an inlet sensor means, connected to the controller, for measuring an inlet permeate fluid concentration of the feed fluid entering the feed inlet means. In some embodiments the energy management system also includes orifice means for metering flow into the purge inlet means.

There has thus been outlined, rather broadly, certain embodiments of the invention in order that the detailed description thereof herein may be better understood, and in order that the contribution to the art may be better appreciated. There are, of course, additional embodiments of the invention that will be described below and which will form the subject matter of the claim appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 is a schematic showing of an energy management system, according to an embodiment of the invention.

FIG. 2 is a schematic showing of an energy management system, according to another embodiment of the invention.

FIG. 3 is a schematic showing of an energy management system, according to yet another embodiment of the invention.

### DETAILED DESCRIPTION

Various embodiments of the invention provide for an energy management system for use with, for example, a membrane separation device. In some arrangements, the invention may be utilized as an energy conservation feature for modulating purge gas consumption of a compressed air membrane dryer by incorporating a device to measure the level of contaminants in the purge gas exiting the membrane. It should be understood, however, that the invention is not limited in its application to compressed air membrane dryer systems, but, for example, with other gas separation systems that utilize a product fluid sweep. Embodiments of the invention will now be further described with reference to the drawing figures, in which like reference numbers refer to like parts throughout.

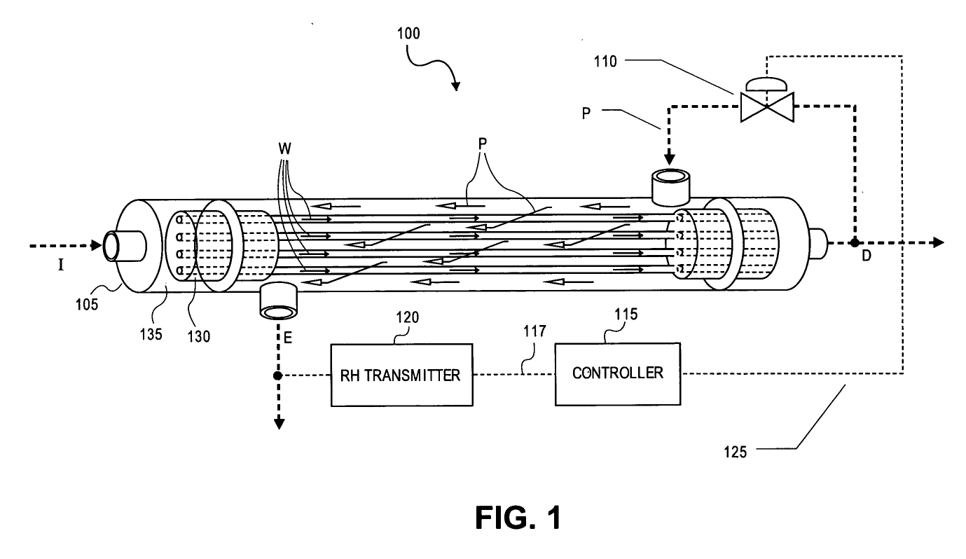

FIG. 1 is a schematic showing of an energy management system 100, according to an embodiment of the invention. The system 100 may be used in conjunction with a membrane separation device, such as a membrane dryer 105, as shown in FIG. 1. The membrane dryer 105 may be attached to a purge flow control valve 110 which may be controlled by a controller 115. The controller 115 may receive an analog output signal 117 from a sensor, such as an RH Transmitter 120, which measures concentration levels of a certain fluid stream. In example embodiments of the invention, a valve control signal 125, which may be pneumatic, electrical or other suitable form, enables communication between the controller 115 and the purge flow control valve 110.

In example embodiments of the invention, wet compressed air W from a compressor may enter the membrane dryer 105 at wet air inlet I. The compressed air passes through a membrane fiber bundle 130, which is housed within a membrane dryer shell or bowl 135. The membrane fiber bundle 130, which may be helical or other shapes, is specifically designed to attract water vapor and in one embodiment of the invention, may be comprised of a bundle of hollow fibers. As air passes through the hollow membrane fibers of the membrane fiber bundle 130, water vapor is absorbed from the stream W.

In example embodiments of the invention, a differential partial pressure of water vapor exists between the inside of the membrane fiber bundle 130 and the outside so that water vapors will migrate to the outside shell of the fiber bundle 130. Thus, as the compressed air inlet stream W passes through the inside of the membrane fibers, the water vapor is absorbed on the membrane material coating the fibers and passes quickly through the walls of the fibers to the outer layers of the membrane. In order to operate continuously, the outer layers of the bundle 130 must be purged of water vapors, as further discussed below.

The bulk of the dry air travels through the membrane dryer 105 and exits the system 100 through a dry air outlet D. The product dry air is then used to perform work or otherwise used in industrial processing and manufacturing. A smaller portion of the product dry air is diverted to the purge flow control valve 110. In example embodiments, such as for use with a proportional solenoid valve, the control valve may utilize a continuously variable throttle, for example 1-5 volts or more of direct current (VDC), to enable continuous changes in flow amounts.

In example embodiments of the invention, the purge air stream P may run counter current to the inlet stream W and at lower pressure, creating a driving force for the drying process. The purge air that passes through the open valve 110 is swept across the outside of the membrane fiber bundle 130, creating a moisture gradient. As such, once the water vapor reaches the outside of the membrane fiber bundle 130, it is swept off the surface by the purge air inlet stream P. This low pressure wet purge air, is then exhausted from the system 100 through purge exhaust stream E.

In example embodiments of the invention, the RH transmitter 120 measures the quantity of water vapor that exists in a gaseous mixture of air and water that is exhausted from the system 100 in the purge exhaust stream E. In this example embodiment, RH may be defined as the ratio of the partial pressure of water vapor in the gaseous mixture of air and water in stream P to the saturated vapor pressure of water at a given temperature.

In example embodiments of the invention, the wet air inlet stream W may be saturated with water vapor. With adequate membrane surface area and a low ratio of purge to inlet flow, the saturation level in the purge air will approach that of the inlet air prior to reaching the purge exhaust port. In that embodiment, each unit volume of purge air would carry the maximum possible volume of water vapor such that the purge air is used efficiently. However, the available membrane area would then be underutilized, because once the purge air saturation level comes to equilibrium with that of the wet air inlet stream W, the driving force for water vapor diffusion goes to zero. To fully utilize the available membrane surface, it is therefore desirable that the purge air saturation level not approach that of the inlet air until the purge air arrives at the purge exhaust port.

With the purge stream P set as described above, any reduction in process flow causes the saturation level of the purge exhaust stream E to fall, as there is less moisture available to diffuse across the membrane 130 into a constant flow of purge air P. The resultant reduction in the saturation level of the purge exhaust stream E, as detected by the RH transmitter 120, indicates an excess of the purge flow P. The RH signal 125 may be used to modulate the purge flow control valve 110, which in turn minimizes purge air consumption. For example, when the RH of exhaust stream E decreases, the controller 115 may be configured to communicate to the purge flow control valve 110 and enable it to decrease the purge inlet air stream P.

Example embodiments of the invention may serve as an energy-saving system due to the purge controller components, which allow treatment of compressed air in a system that selectively purges the membrane fiber bundle 130 as needed based on the saturation level of the purge exhaust E. In example embodiments of the invention, air is not lost through continuous or excessive purging.

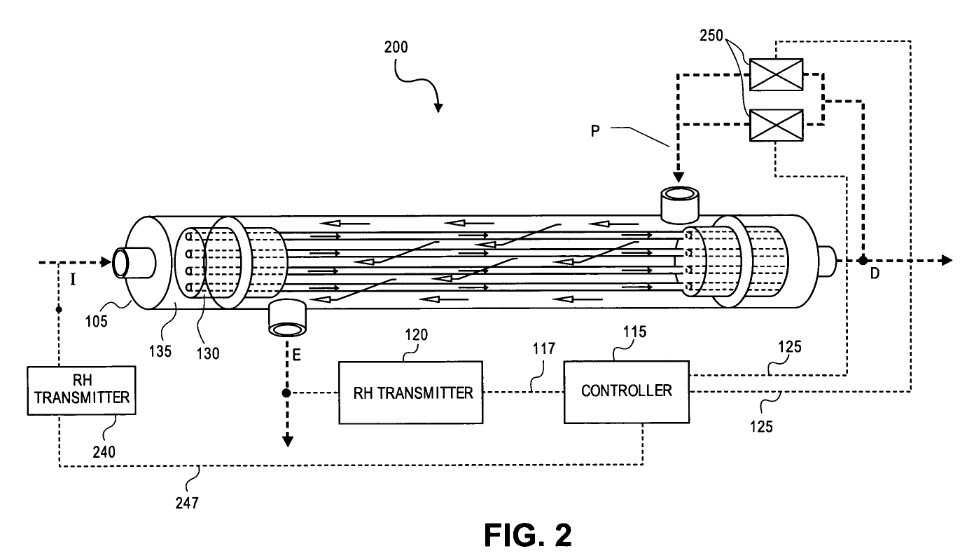

FIG. 2 is a schematic showing an energy management system, according to another embodiment of the invention. In other embodiments of the invention, a second RH transmitter 240 may be installed at the dryer wet compressed air inlet I to detect the inlet saturation level, as shown in FIG. 2. The controller 115 would receive analog output signals 117 and 247 from RH transmitters 120 and 240, respectively. Accordingly, control may then be established based on throttling the purge flow P as the saturation level of the exhaust stream E falls below the saturation level of the inlet stream W.

In example embodiments of the invention, a parallel series of two or more on-off valves 250 may be used in the place of single control valve 110, as shown in FIG. 2. The on-off valves 250, which include for example, multiple solenoid valves, would then modulate the purge flow P in discrete steps. In example embodiments, the valves 250 may be offered in the same or in different sizes to accommodate flow requirements. As such, the purge air inlet P may be controlled by the on-off valves 250, which can electronically, for example digitally, cycle the sweep on and off based on purge air demand.

In example embodiments of the invention, the on-off valves 250 would each receive a separate valve control signal 125 from the controller 115. The on-off valves 250 may be configured to individually open and close to increase or decrease the purge inlet flow P to match the purge requirements as the inlet contaminant level, as measured by the RH transmitter 240, varies. The use of solenoid valves rather than single continuously variable throttle valves greatly decreases the cost of the system 200 while still reducing purge consumption of the membrane fiber bundle 130.

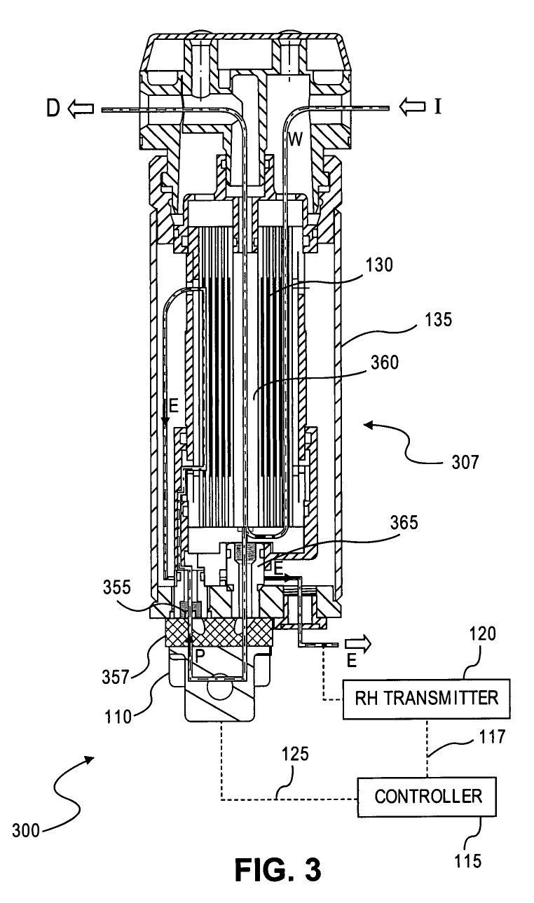

FIG. 3 is a sectional view of a membrane dryer 307 having an integral purge control feature used in conjunction with an energy management system 300, according to another embodiment of the invention. In example embodiments of the invention, the membrane dryer 307 may have an integral purge control feature, as shown in FIG. 3. Example embodiments include a purge control orifice 355 for metering the appropriate amount of purge air and a purge flow control valve 110 mounted to a purge manifold 357 located at the bottom of the membrane dryer 307.

In example embodiments of system 300, the purge flow control valve 110 may be a proportional solenoid valve or a continuously variable flow valve or any other suitable valve that throttles fluid flow. Concurrently, the rate at which purge exhaust exits the purge outlet E may also be controlled by the diameter size of a purge control orifice 355 which meters out sweep air. The diameter size of the purge control orifice 355 can be varied depending on the need of the user. Thus, the purge flow control valve 110 provides an electronic control of the sweep with a feed back loop.

In example embodiments of system 300, the membrane dryer 307 operates similarly to the dryer 105 of systems 100 and 200. Compressed air containing water vapor enters the dryer 307 through the wet air inlet I. The compressed air passes through the membrane fiber bundle 130. As the compressed air passes through the inside of the membrane fibers, the water vapor is absorbed into the membrane and passes quickly through the walls of the fibers to the outer layers of the membrane fiber bundle 130. The bulk of the dry air travels through a transfer tube 360 and leaves the dryer 307 through a dry air outlet D.

In example embodiments of system 300, a smaller portion of the product dry air is diverted through a membrane bundle center fitting 365, which also acts to center the membrane fiber bundle 130 within its housing 135. The purge air is then swept through the sweep manifold 357 and into the purge flow control valve 110. Similarly to systems 200 and 300, the RH of the purge exhaust stream E is measured by RH Transmitter 120. The controller 115 would receive the signal 117 from the RH transmitter 120. The valve 110 is then continuously modulated by controller 115, which receives its valve control signal 125 from the RH Transmitter 120. For example, when the RH of exhaust stream E decreases, the controller may be configured to communicate to the purge flow control valve 110 and enable it to maintain modulated purge flow of stream P. Accordingly, the system 300 maintains minimal purge flow P through the membrane dryer 307.

In certain design conditions, when the wet air inlet stream W is completely saturated, the purge exhaust may have an RH of approximately 90%. If the rate of the wet air inlet flow W is decreased by about 50%, for instance, then the rate at which water vapor is conveyed into the dryer 105 will be reduced by approximately 50% and the ratio of purge flow P to drying flow D would ordinarily double. This increased P/D ratio causes the RH of the purge exhaust stream E to fall and signifies excess purge. In example embodiments of using the invention, when the RH transmitter 120 senses this reduction in RH of the exhaust stream E, the controller 115 would signal the purge control valve 110 or valves 250 to reduce the flow until the purge exhaust rises once again to about 90% RH. Accordingly, the purge flow P may be reduced by approximately 50% to reach the about 90% saturation level of the exhaust stream E, because about 50% less moisture is being delivered to the membrane fiber bundle 130. This energy management system 100, 200 or 300 would then result in a purge savings of 50%. The same analysis could be applied to any given reduction in the rate of inlet flow W.

Thus, the purge savings percentage is directly proportional to the percentage reduction in inlet flow W. In other embodiments of the invention, the controller 115 would be able to make similar adjustments if there are changes in RH or pressure of the inlet stream W which changes the rate at which water vapor is delivered to the membrane fiber bundle 130 because the RH transmitter 120 would detect the resulting change in RH of the exhaust E. The controller 115 would then receive the signal 117 from the RH transmitter 120 and send a valve control signal 125 to the valve 110 to adjust the rate of the purge inlet flow P.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An energy management system, comprising:
a membrane separation device, wherein the membrane separation device comprises:
a membrane having permeate and non-permeate portions;
a membrane housing which encases said membrane;
a feed fluid inlet conduit;
a purge inlet conduit;
a non-permeate product fluid outlet conduit; and,
a purge outlet conduit, configured to carry a purge fluid out of the membrane separation device;
at least one purge inlet flow control valve connected to said purge inlet conduit,
an exhaust sensor configured to measure an exhaust permeate fluid concentration of fluids exiting the purge outlet conduit; and,
a controller receiving an output signal from the exhaust sensor and transmitting a valve control signal to the at least one purge inlet flow control valve.

2. The energy management system of claim 1, wherein the exhaust sensor includes a relative humidity transmitter.

3. The energy management system of claim 1, wherein the membrane separation device includes an integral purge control feature.

4. The energy management system of claim 1, wherein the membrane separation device includes hollow fiber membranes.

5. The energy management system of claim 1, wherein the membrane separation device includes a membrane dryer.

6. The energy management system of claim 1, wherein the at least one purge inlet flow control valve is configured to provide continuously modifiable flow rates.

7. The energy management system of claim 1, wherein the at least one purge inlet flow control valve includes a plurality of on-off valves each connected to the controller.

8. The energy management system of claim 7, wherein the plurality of on-off valves includes at least two solenoid valves.

9. The energy management system of claim 7, further comprising an inlet sensor configured to measure an inlet permeate fluid concentration of fluids entering the feed fluid inlet conduit.

10. The energy management system of claim 1, further comprising an inlet sensor configured to measure an inlet permeate fluid concentration of fluids entering the feed fluid inlet conduit connected to the controller.

11. The energy management system of claim 1, further comprising an orifice for metering flow into the purge inlet conduit.

12. The energy management system of claim 1, further comprising a manifold mounted to the membrane housing.

13. The energy management system of claim 12, wherein the at least one purge inlet flow control valve is mounted to the manifold.

14. A method of using an energy management system in conjunction with a membrane separation device, comprising:
directing fluid into the membrane separation device, wherein the membrane separation device comprises:
a membrane having permeate and non-permeate portions;
a membrane housing which encases said membrane;
a feed fluid inlet conduit;
a purge inlet conduit;
a non-permeate product fluid outlet conduit; and,
a purge outlet conduit, configured to carry an exhaust fluid out of the membrane separation device;
measuring an outlet permeate fluid concentration of fluids exiting the purge outlet conduit using an exhaust sensor;
transmitting a first output signal from the exhaust sensor to a controller;
transmitting a valve control signal from the controller to at least one purge inlet flow control valve; and
directing flow into the purge inlet conduit based on the measured outlet permeate fluid concentration and using the at least one purge inlet flow control valve connected between said purge inlet conduit and said controller.

15. The method of using the energy management system of claim 14, wherein the exhaust sensor is a relative humidity transmitter.

16. The method of using the energy management system of claim 14, further comprising:
measuring an inlet permeate fluid concentration of feed fluid entering the feed fluid inlet conduit using an inlet sensor;
transmitting a second output signal from the inlet exhaust sensor to the controller.

17. The method of using the energy management system of claim 14, wherein directing flow into the purge inlet conduit using the at least one purge inlet flow control valve connected between said purge inlet conduit and said controller further comprises configuring the at least one purge inlet flow control valve to provide continuously modifiable flow rates.

18. The method of using the energy management system of claim 14, wherein transmitting the valve control signal from the controller to the at least one purge inlet flow control valve includes transmitting the valve control signal to a plurality of on-off valves.

19. The method of using the energy management system of claim 14, further comprising metering flow into the purge inlet conduit using an orifice.

20. An energy management system, comprising:
membrane separation means for separating a permeate fluid from a non-permeate fluid, including:
membrane housing means for encasing said membrane separation means;
feed inlet means for flowing a feed fluid into the membrane separation means;
purge inlet means for flowing a purge fluid into the membrane separation means;
product outlet means for flowing a product fluid out of the membrane separation means; and,
purge outlet means for flowing an exhaust fluid out of the membrane separation means;
purge inlet flow control means for controlling the flow of purge fluid into the purge inlet means,
exhaust sensor means for measuring an exhaust permeate fluid concentration of exhaust fluid exiting the purge outlet means; and
controller means for receiving an output signal from the exhaust sensor means and transmitting a valve control signal to the purge inlet flow control means.

21. The energy management system of claim 20, further comprising an inlet sensor means, connected to the controller, for measuring an inlet permeate fluid concentration of the feed fluid entering the feed inlet means.

22. The energy management system of claim 20, further comprising orifice means for metering flow into the purge inlet means.
